(19) United States
(12) Patent Application Publication
(10) Pub. No.: US 2021/0325886 A1
(43) Pub. Date: Oct. 21, 2021

(54) PHOTOGRAPHING METHOD AND DEVICE

(71) Applicant: SZ DJI TECHNOLOGY CO., LTD., Shenzhen (CN)

(72) Inventors: Yang LI, Shenzhen (CN); Maojiang LIN, Shenzhen (CN)

(21) Appl. No.: 17/361,750

(22) Filed: Jun. 29, 2021

Related U.S. Application Data
(63) Continuation of application No. PCT/CN2018/125606, filed on Dec. 29, 2018.

(51) Int. Cl. G05D 1/00; G06T 7/62; H04N 5/232; G05D 1/08; G05D 1/10; B64D 47/08; G08G 5/04; G08G 5/00

(52) U.S. Cl. CPC G05D 1/0094; G06T 7/62; H04N 5/23299; G05D 1/0808; G06T 2207/30181; B64D 47/08; G08G 5/04; G08G 5/0069; G08G 5/0039; G05D 1/106

(57) ABSTRACT

A photographing method includes photographing a target object during flight along a first predetermined direction, determining a surrounding-start position for flight around the target object, flying around the target object starting from the surrounding-start position, photographing the target object during the flight around the target object, determining a surrounding-end position for ending the flight around the target object, flying along a second predetermined direction starting from the surrounding-end position, and photographing the target object during flight along the second predetermined direction.

### CROSS-REFERENCE TO RELATED APPLICATION

This application is a continuation of International Application No. PCT/CN2018/125606, filed Dec. 29, 2018, the entire content of which is incorporated herein by reference.

### TECHNICAL FIELD

The present disclosure generally relates to the unmanned aerial vehicle technology field and, more particularly, to a photographing method and a device.

### BACKGROUND

With the rapid development of technology, many unmanned aerial vehicles (UAV) have a photographing function. Users can use UAVs to photograph various interesting videos. However, it is desired to solve the problem of how to use a UAV to photograph awesome videos.

### SUMMARY

Embodiments of the present disclosure provide a photographing method. The method includes photographing a target object during flight along a first predetermined direction, determining a surrounding-start position for flight around the target object, flying around the target object starting from the surrounding-start position, photographing the target object during the flight around the target object, determining a surrounding-end position for ending the flight around the target object, flying along a second predetermined direction starting from the surrounding-end position, and photographing the target object during flight along the second predetermined direction.

Embodiments of the present disclosure provide a photographing device including an image capture apparatus, a processor, and a flight apparatus. The image capture apparatus is configured to photograph a target object during flight along a first predetermined direction, during flight around the target object, and during flight along a second predetermined direction. The processor is configured to determine a surrounding-start position for the flight around the target object and a surrounding-end position for ending the flight around the target object. The flight apparatus is configured to fly around the target object starting from the surrounding-start position and along the second predetermined direction starting from the surrounding-end position.

### BRIEF DESCRIPTION OF THE DRAWINGS

FIG. 1 is a schematic architectural diagram of an aircraft according to some embodiments of the present disclosure.

FIG. 2 is a schematic flowchart of a photographing method according to some embodiments of the present disclosure.

FIG. 3 is a schematic diagram showing a scene according to some embodiments of the present disclosure.

FIG. 4 is a schematic flowchart showing a method of determining a surrounding-start position according to some embodiments of the present disclosure.

FIG. 5 is a schematic flowchart showing a method of determining a surrounding-start position according to some embodiments of the present disclosure.

FIG. 6 is a schematic flowchart showing a method of determining a surrounding-start position according to some embodiments of the present disclosure.

FIG. 7 is a schematic flowchart showing a method of determining a surrounding-end position according to some embodiments of the present disclosure.

FIG. 8 is a schematic flowchart showing a method of determining a surrounding-end position according to some embodiments of the present disclosure.

FIG. 9 is a schematic flowchart showing a method of determining a surrounding-end position according to some embodiments of the present disclosure.

FIG. 10 is a schematic flowchart of a surrounding flight method according to some embodiments of the present disclosure.

FIG. 11 is a schematic structural diagram of a photographing device according to some embodiments of the present disclosure.

### DETAILED DESCRIPTION OF THE EMBODIMENTS

To make the purposes, features, and advantages of the present disclosure clearer, the present disclosure is described in detail in connection with the accompanying drawings and specific embodiments.

Embodiments of the present disclosure provide a photographing method and a device. The photographing method and the device may be applied to an aircraft. The aircraft, for example, may include a rotorcraft, such as a multi-rotor aircraft propelled by a plurality of propulsion devices through the air, which is not limited by embodiments of the present disclosure.

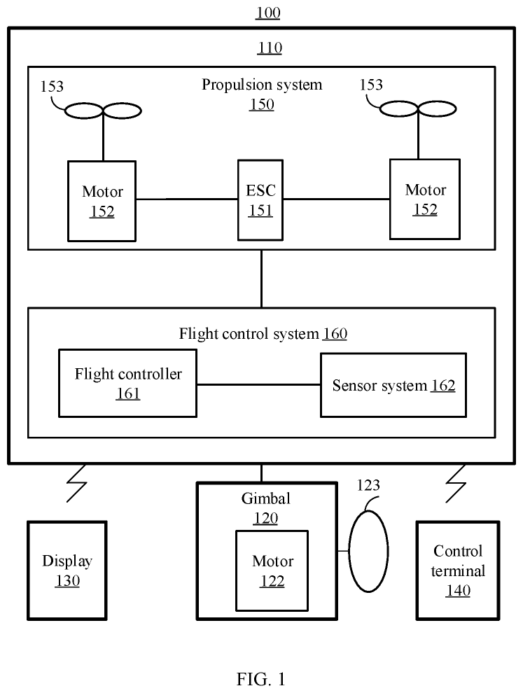

FIG. 1 is a schematic architectural diagram of an aircraft 100 according to some embodiments of the present disclosure. In embodiments of the present disclosure, the rotorcraft is taken as an example for description.

The aircraft 100 includes an unmanned aerial vehicle 110 (i.e., flight apparatus of a photographing device of the present disclosure), a display 130, and a control terminal 140. The UAV 110 includes a propulsion system 150, a flight control system 160, a vehicle frame, and a gimbal 120 carried by the vehicle frame. The UAV 110 may communicate with the control terminal 140 and the display 130 wirelessly.

The vehicle frame includes a vehicle body and a stand (landing gear). The vehicle body may include a center frame and one or more vehicle arms connected to the center frame. The one or more vehicle arms may extend radially from the center frame. The stand may be connected to the vehicle body and configured to support the UAV 110 during landing.

The propulsion system 150 includes one or more electronic speed controls (ESCs) 151, one or more propellers 153, and one or more motors 152 corresponding to the one or more propellers 153. A motor 152 is connected between an ESC 151 and a propeller 153. The motor 152 and the propeller 153 may be arranged at a vehicle arm of the UAV 110. The ESC 151 may be configured to receive a drive signal generated by the flight control system 160 and provide a drive current to the motor 152 according to the drive signal to control the rotation speed of the motor 152. The motor 152 may be configured to drive the propeller to rotate to provide power to the flight of the UAV 110. The power may cause the UAV 110 to realize the movement of one or more degrees of freedom. In some embodiments, the UAV 110 may rotate around one or more rotation axes. For example, the rotation axes may include a roll axis, a yaw axis, and a pitch axis. The motor 152 may include a direct current (DC) motor or an alternating current (AC) motor. The motor 152 may include a brushless motor or a brushed motor.

The flight control system 160 includes a flight controller 161 and a sensor system 162. The sensor system 162 may be configured to measure attitude information of the UAV, that is, position information and status information of the UAV 110 in space, for example, 3 dimensional (3D) position, 3D angle, 3D speed, 3D acceleration, and 3D angular speed. The sensor system 162, for example, may include at least one of a gyroscope, an ultrasonic sensor, an electronic compass, an inertial measurement unit (IMU), a vision sensor, a global navigation satellite system, or a barometer. For example, the global navigation satellite system may include a global positioning system (GPS). The flight controller 161 may be configured to control the flight of the UAV 110, for example, according to the attitude information measured by the sensor system 162. The flight controller 161 may control the UAV 110 according to program instructions that are programmed in advance or by responding to one or more control instructions from the control terminal 140.

The gimbal 120 includes a motor 122. The gimbal may be configured to carry an image capture apparatus 123. The flight controller 161 may be configured to control the movement of the gimbal 120 through the motor 122. In some embodiments, the gimbal 120 may include a controller, which may be configured to control the movement of the gimbal 120 by controlling the motor 122. The gimbal 120 may be independent of the UAV 110 or a portion of the UAV 110. The motor 122 may include a DC motor or an AC motor. The motor 122 may include a brushless motor or a brushed motor. The gimbal 120 may be arranged at a top of the UAV 110 or the bottom of the UAV 110.

The image capture apparatus 123 may include an apparatus configured to capture an image such as a camera or a recorder. The image capture apparatus 123 may be configured to communicate with the flight controller and photograph under the control of the flight controller. The image capture apparatus 123 of embodiments of the present disclosure may at least include a photosensitive element. The photosensitive element, for example, may include a complementary metal-oxide-semiconductor (CMOS) sensor or a charge-coupled device (CCD) sensor. The image capture apparatus 123 may be fixed directly at the UAV 110. Thus, the gimbal 120 may be omitted.

The display 130 may be located at a ground end of the aircraft 100 and may be configured to communicate with the UAV 110 wirelessly and display the attitude information of the UAV 110. In addition, the image captured by an imaging device may be displayed on the display 130. The display 130 may be an independent apparatus or integrated at the control terminal 140.

The control terminal 140 may be at the ground end of the aircraft 100 and configured to communicate with the UAV 110 wirelessly and control the UAV 110 remotely.

In addition, the UAV 110 may include an onboard loudspeaker (not shown). The loudspeaker may be configured to broadcast an audio file. The loudspeaker may be fixed at the UAV 110 or carried by the gimbal 120.

Names of components of an unmanned aerial system are merely for identification purposes, which should not be understood as limitations of embodiments of the present disclosure. A photographing control method of embodiments of the present disclosure may be executed by the flight controller 161 to control the image capture apparatus 123 to perform photographing.

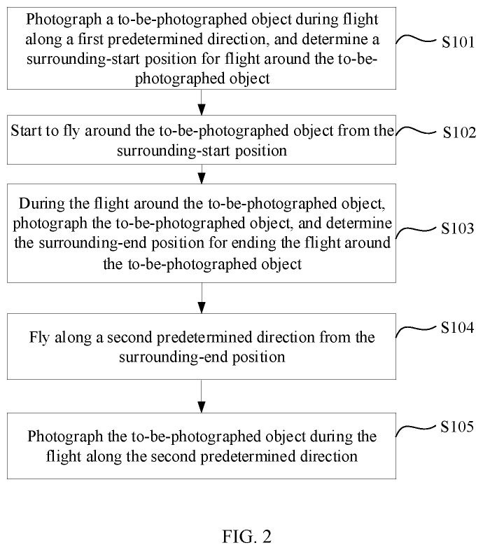

FIG. 2 is a schematic flowchart of a photographing method according to some embodiments of the present disclosure. The method may be implemented by the aircraft. The method includes the following processes.

At S101, a to-be-photographed object is photographed during flight along a first predetermined direction, and a surrounding-start position for flight around the to-be-photographed object is determined. The to-be-photographed object is also referred to as a “target object.”

In some embodiments, before the aircraft is in flight, the aircraft may receive a determined flight direction, which may be used as the first predetermined direction. For example, a user may input the determined flight direction into a remote controller that may be configured to control the aircraft. The remote controller may receive the determined flight direction input by the user and send the determined flight direction to the aircraft. The aircraft may receive the determined flight direction sent by the remote controller and use the determined flight direction as the first predetermined direction.

The first predetermined direction may include a direction pointing to the to-be-photographed object or a position around the to-be-photographed object. The aircraft that flies along the first predetermined direction may be getting closer to the to-be-photographed object.

In some embodiments, before the aircraft is in flight, the aircraft may receive a determined flight position. A direction from the current position of the aircraft to the flight position may be determined as the first predetermined direction. For example, the user may input the determined flight position into the remote controller that may be configured to control the aircraft. The remote controller may receive the determined flight position input by the user and send the determined flight position to the aircraft. The aircraft may receive the determined flight position sent by the remote controller and determine the direction from the current position of the aircraft to the flight position as the first predetermined direction.

The flight position may include a position where the to-be-photographed object is or a position around the to-be-photographed object. When the aircraft flies to the position around the to-be-photographed object, the aircraft may be getting closer to the to-be-photographed object.

In the present disclosure, the aircraft may need to perform traverse back photographing on the to-be-photographed object. That is, a photographing field of view of the aircraft may be getting closer to the to-be-photographed object, and the to-be-photographed object may be photographed when the photographing field of view of the aircraft is getting closer to the to-be-photographed object. Moreover, when the photographing field of view of the aircraft is getting closer to the to-be-photographed object, the aircraft may continue to perform surround-photographing on the to-be-photographed object. When the surround-photographing ends, the photographing field of view may be getting away from and photograph the to-be-photographed object. As such, a special field of view may be realized through continuous flight movement to continuously photograph the to-be-photographed object. Therefore, since the aircraft needs to fly surround and photograph the to-be-photographed object when flying around the to-be-photographed object, the surrounding-start position for the flight around the to-be-photographed object may need to be determined. Then, the aircraft may start flying around the to-be-photographed object.

For the method used to determine the surrounding-start position for the flight around the to-be-photographed object, reference may be made to the methods shown in FIG. 4-FIG. 6, which is not described in detail here.

During the flight of the aircraft, a photographing direction of the aircraft may be adjusted, such that the to-be-photographed object may be located in a predetermined area of a preview image in at least a portion of a surrounding path of the flight around the to-be-photographed object. The predetermined area may include a center area of the preview image. As such, the position of the to-be-photographed object in the preview image may be adjusted according to the user needs to realize a variety of photographing effects. Further, the image capture apparatus may be carried by the aircraft. During the flight of the aircraft, the photographing direction of the aircraft may be adjusted, that is, a head orientation (by taking that the head orientation of the aircraft is same as the photographing direction of the aircraft as an example for description, and an end of the aircraft including the image capture apparatus being the head) of the aircraft may be compensated and corrected. Thus, when the aircraft enters or exits the surround-photographing, continuity and stability of captured pictures may be ensured, and an abrupt change of the captured pictures caused by the abrupt flight direction change may be avoided.

For example, in some embodiments, in at least the portion of the flight path of the flight along the first predetermined direction, the photographing direction of the aircraft may be adjusted, such that the to-be-photographed object may be located in the predetermined area of the preview image in at least the portion of the photographing path of the aircraft. At least the portion of the photographing path may include the surrounding path. A length of at least the portion of the photographing path may be longer than a length of the surrounding path. Thus, as long as the to-be-photographed object may be ensured to be located in the predetermined area of the preview image in a portion of a surrounding process, and the to-be-photographed object may be ensured to be located in the preview image in another photographing process.

In some other embodiments, during the flight of the aircraft, the photographing direction of the aircraft may be adjusted, such that the to-be-photographed object may be located in the predetermined area of the preview image. In some embodiments, in the flight of the aircraft, the photographing direction of the aircraft may be adjusted continuously, such that the to-be-photographed object may be always located in the predetermined area of the preview image in the photographing path of the aircraft. As such, when viewing the preview image, the user may always see the to-be-photographed object in the predetermined area.

The photographing direction of the aircraft may be adjusted by adjusting the attitude of the aircraft or the attitude of the gimbal carried by the aircraft (the image capture apparatus being carried by the gimbal).

For example, the photographing direction of the aircraft being adjusted during the flight along the first predetermined direction is taken as an example for description. Before the aircraft flies along the first predetermined direction, the length of the flight path of the flight along the first predetermined direction may be determined. For example, a distance between the current position of the aircraft and the surrounding-start position may be determined and used as the length of the flight path. A first camera angle of the aircraft may be determined when the aircraft flies along the first predetermined direction, and a second camera angle of the aircraft at the surrounding-start position may be determined. For example, the to-be-photographed object photographed at the first camera angle may be in the predetermined area of the preview image, and the to-be-photographed object photographed at the second camera angle may be in the predetermined area of the preview image. Thus, an angle difference between the second camera angle and the first camera angle may be continuously determined. A ratio between the angle difference and the length of the flight path may be calculated to obtain a unit camera angle of the aircraft that needs to be adjusted for the path of every flight unit length. As such, when the aircraft flies along the first predetermined direction, in the path of every flight unit length, the photographing direction of the flight may be adjusted to the unit camera angle. Thus, when the aircraft flies to the surrounding-start position, the to-be-photographed object photographed by the aircraft may be in the predetermined area of the preview image.

At S102, the aircraft starts to fly around the to-be-photographed object from the surrounding-start position.

At S103, during the flight around the to-be-photographed object, the to-be-photographed object is photographed, and the surrounding-end position for ending the flight around the to-be-photographed object is determined.

During the flight around the to-be-photographed object, the aircraft may control the image capture apparatus arranged at the aircraft to photograph the to-be-photographed object.

During the flight around the to-be-photographed object, the photographing direction of the aircraft may be adjusted, such that the to-be-photographed object may be in the predetermined area of the preview image in at least the portion of the surrounding path of the flight around the to-be-photographed object. The predetermined area may include the center area of the preview image.

In the present disclosure, the aircraft may need to perform traverse back photographing on the to-be-photographed object, that is, the aircraft may need to fly around the to-be-photographed object and photograph the to-be-photographed when flying around the to-be-photographed object, but the aircraft may not fly around the to-be-photographed object unrestrictedly and continuously. Therefore, the surrounding-end position for the flight around the to-be-photographed object may be determined, and the aircraft may no longer fly around the to-be-photographed object from the surrounding-end position.

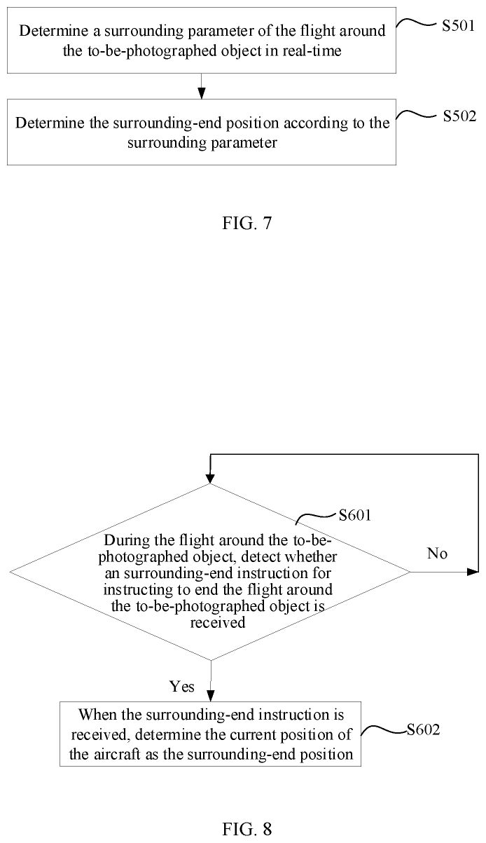

For the method of determining the surrounding-end position for ending the flight around the to-be-photographed object, reference may be made to the method shown in FIGS. 7-9, which is not detailed here.

At S104, the aircraft flies along a second predetermined direction from the surrounding-end position.

In some embodiments, after the surrounding flight ends, the flight direction of the aircraft may be determined and used as the second predetermined direction. Then, the aircraft may fly along the second predetermined direction from the surrounding-end position.

In some embodiments, the first predetermined direction and the second predetermined direction may be symmetrical about the line from the to-be-photographed object to the middle point of the surrounding path around the to-be-photographed object.

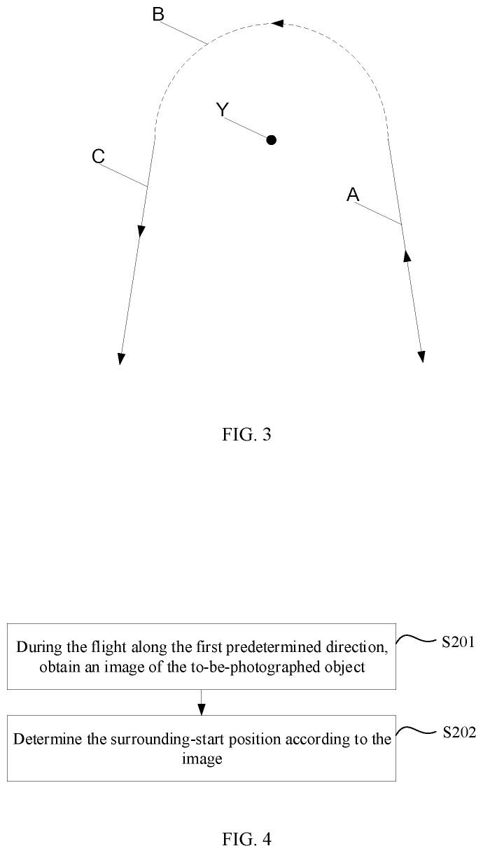

For example, as shown in FIG. 3, the first predetermined direction is a direction indicated by an arrow of straight-line A. A direction when the aircraft flies around the to-be-photographed object is a direction indicated by an arrow of arc B. The second predetermined direction is a direction indicated by an arrow of straight-line C.

The first predetermined direction may indicate a direction of continuously getting closer to the to-be-photographed object. The second predetermined direction may indicate a direction of continuously getting away from the to-be-photographed object. The second predetermined direction is not limited to the above description and may include another direction in practical applications. For example, the second predetermined direction may intersect with the first predetermined direction, which is not limited here.

At S105, the to-be-photographed object is photographed during the flight along the second predetermined direction.

In some embodiments, during the flight of the aircraft, the photographing direction of the aircraft may be adjusted, such that the to-be-photographed object may be in the predetermined area of the preview image in at least the portion of the surrounding path of the flight around the to-be-photographed object. The predetermined area may include the center area of the preview image.

For example, in some embodiments, in at least the portion of the flight path of the flight along the second predetermined direction, the photographing direction of the aircraft may be adjusted, such that the to-be-photographed object may be in the predetermined area of the preview image in at least the portion of the photographing path of the aircraft. At least the portion of the photographing path may include the surrounding path, and a length of at least the portion of the photographing path may be longer than the length of the surrounding path. In some other embodiments, during the flight of the aircraft, the photographing direction of the aircraft may be adjusted, such that the to-be-photographed object may be in the predetermined area of the preview image. For corresponding contents of embodiments described here, reference may be made to the previous content, and the only difference is that the second predetermined direction is described here instead of the first predetermined direction, which is not repeated here.

In some embodiments, a flight distance that the aircraft flies along the first predetermined direction may be same as a flight distance that the aircraft flies along the second predetermined direction. In some other embodiments, the flight distance that the aircraft flies along the first predetermined direction may be different from the flight distance that the aircraft flies along the second predetermined direction, which may be designed as needed.

Further, the end of the aircraft including the image capture apparatus is taken as an example of the head. During the flight of the aircraft along the second predetermined direction from the surrounding-end position, the head orientation of the aircraft and the photographing direction may include the following relationship.

In some embodiments, during the flight of the aircraft along the second predetermined direction from the surrounding-end position, the head orientation of the aircraft may be opposite to the photographing direction of the aircraft or have an obtuse angle with the photographing direction. As such, during the flight along the second predetermined direction, the head orientation of the aircraft may be adjusted, and the photographing direction of the image capture apparatus may be adjusted through the gimbal. Thus, the head orientation of the aircraft may be the same as the flight direction of the aircraft, which facilitates performing corresponding aircraft control to realize video recording effects of the present disclosure.

In some other embodiments of the present disclosure, during the flight of the aircraft along the second predetermined direction from the surrounding-end position, the head orientation of the aircraft may be the same as the photographing direction of the aircraft. That is, the head orientation of the aircraft may be opposite to or have an obtuse angle with the flight direction of the UAV to realize a back flight mode. As such, when the aircraft starts photographing from the surrounding-end position, the head orientation of the aircraft may not be adjusted, and only the flight direction of the aircraft may need to be changed to support stable photographing of the aircraft and the clarity of the image of the to-be-photographed object.

In the present disclosure, the aircraft may photograph the to-be-photographed object during the flight along the first predetermined direction, determine the surrounding-start position for the flight around the to-be-photographed object, fly around the to-be-photographed object starting from the surrounding-start position, photograph the to-be-photographed object during the flight around the to-be-photographed object, determine the surrounding-end position for ending the flight around the to-be-photographed object, fly along the second predetermined direction starting from the surrounding-end position, and photograph the to-be-photographed object during the flight along the second predetermined direction. As such, in the present disclosure, the following effects of the awesome video may be recorded by the aircraft for the to-be-photographed object. The photographing field of view of the aircraft may be getting closer to the to-be-photographed object continuously. The to-be-photographed object may be photographed when the photographing field of view is getting closer to the to-be-photographed object. When the photographing field of view gets close to the photographing field of view, the aircraft may continue to surround photograph the to-be-photographed object. When the surround-photographing is ended, the photographing field of view may be getting away from the to-be-photographed object continuously. As such, the to-be-photographed object may be photographed continuously with a special field of view through continuous flight actions.

In some embodiments, as shown in FIG. 4, determining the surrounding-start position for the flight around the to-be-photographed object includes the following processes.

At S201, during the flight along the first predetermined direction, an image of the to-be-photographed object are obtained.

In the present disclosure, during the flight along the first predetermined direction, the image capture apparatus may be configured to capture an image including the to-be-photographed object (image including a portion of the to-be-photographed object or the whole to-be-photographed object). The image may include a captured image of the to-be-photographed object or a preview image of the to-be-photographed object.

The preview image may include an image after the captured image is compressed or an image after the captured image is cropped. The preview image may be displayed at the control terminal of the aircraft. The captured image of the to-be-photographed object may include an original image obtained during photographing, which may not be transmitted to the control terminal of the aircraft.

At S202, the surrounding-start position is determined according to the image.

In some embodiments, a dimension ratio of the dimension of the to-be-photographed object may be determined in the image. When the dimension ratio is greater than or equal to a predetermined ratio, the current position of the aircraft may be determined as the surrounding-start position.

The dimension of the to-be-photographed object may include the dimension of the profile of the to-be-photographed object and a dimension of a portion of the frame or the whole frame of the to-be-photographed object. The frame may include a regular frame or a circular frame, which is not limited by the present disclosure.

In the present disclosure, during the flight along the first predetermined direction, the aircraft may be getting closer to the to-be-photographed object. The dimension of the to-be-photographed object may take a larger and larger ratio in the image. The whole appearance of the to-be-photographed object is desired to be photographed, and the to-be-photographed object is desired to take a certain dimension in the image. Thus, when the length or width of the dimension of the to-be-photographed object is equal to the length or width of the image or the length or width of the dimension of the to-be-photographed object is equal to the predetermined length or the predetermined width, the current position of the aircraft may be determined as the surrounding-start position.

In some embodiments, the position of the to-be-photographed object may be determined in the image, when the position is in a predetermined position area, the current position of the aircraft may be determined as the surrounding-start position. In some other embodiments, the position of the frame including a portion of the to-be-photographed object or the whole to-be-photographed object may be determined in the image. When the position is in the predetermined position area, the current position of the aircraft may be determined as the surrounding-start position.

In the present disclosure, the predetermined position area may include an edge area of the image. As shown in FIG. 2, the first predetermined direction is indicated by the arrow of straight-line A. During the flight of the aircraft along the first predetermined direction, the head of the aircraft may face the first predetermined direction. The image capture apparatus may also face the first predetermined direction. During the flight of the aircraft along the first predetermined direction, the position of the to-be-photographed object in the image that is captured may change continuously. When the position of the to-be-photographed object in the image reaches an edge position, if the aircraft continues to fly along the first predetermined direction, the complete to-be-photographed object cannot be obtained by photographing. Thus, the current position of the aircraft may be determined as the surrounding-start position.

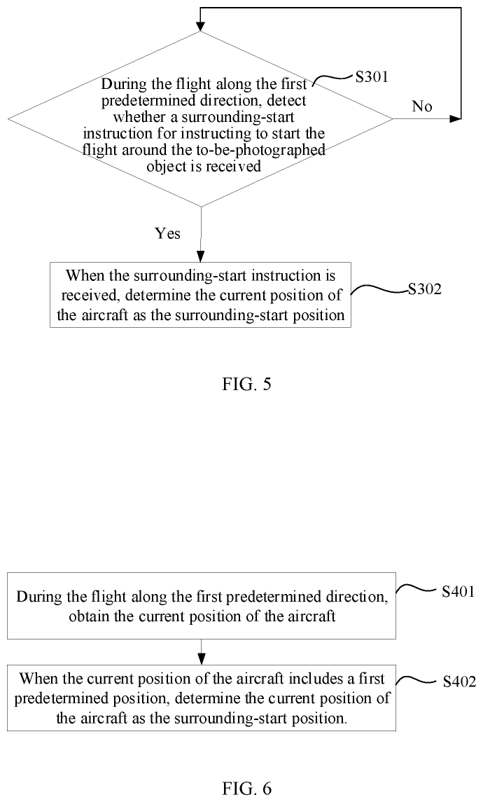

In some embodiments, as shown in FIG. 5, determining the surrounding-start position for the flight around the to-be-photographed object includes the following processes.

At S301, during the flight along the first predetermined direction, whether a surrounding-start instruction for instructing to start the flight around the to-be-photographed object is received is detected.

In some embodiments, during the flight along the first predetermined direction, the aircraft may continuously use the image capture apparatus to capture the image including the to-be-photographed object. Then, the captured image may be transmitted to the remote controller, which is configured to control the aircraft. The remote controller may receive the image transmitted by the aircraft and display the image on the display. After the user sees the image displayed on the display of the remote controller, the user may see the to-be-photographed object in the image. The user may determine when to control the aircraft to start the flight around the to-be-photographed object according to the position of the to-be-photographed object in the image. When the aircraft needs to be controlled to start the flight around the to-be-photographed object, the user may input the surrounding-start instruction for instructing to start the flight around the to-be-photographed object into the remote controller. The remote controller may receive the surrounding-start instruction and transmit the surrounding-start instruction to the aircraft. The aircraft may receive the surrounding-start instruction.

When the surrounding-start instruction is received, in process S302, the current position of the aircraft is determined as the surrounding-start position.

In some embodiments, as shown in FIG. 6, determining the surrounding-start position for the flight around the to-be-photographed object includes the following processes.

At S401, during the flight along the first predetermined direction, the current position of the aircraft is obtained.

During the flight of the aircraft along the first predetermined direction, the aircraft may be positioned in real-time to obtain the current position of the aircraft. Thus, the surrounding-start position may be determined according to the current position of the aircraft.

At S402, when the current position of the aircraft includes a first predetermined position, the current position of the aircraft is determined as the surrounding-start position.

In some embodiments, before flying along the first predetermined direction, the aircraft may capture the image including the to-be-photographed object and then transmit the captured image to the remote controller, which may be configured to control the aircraft. The remote controller may receive the image transmitted by the aircraft and display the image on the display. After the user sees the image displayed on the display of the remote controller, the user may see the to-be-photographed object in the image to determine one position as the surrounding-start position in the image. The remote controller may receive the one position determined by the user in the image. The position of the one position in the actual space may be determined by using image recognition technology. Then, the determined position in the actual space may be sent to the aircraft. The aircraft may receive and use the position in the actual space as the first predetermined position.

In some other embodiments, the user may directly input one position in the actual space into the remote controller as the surrounding-start position. The remote controller may receive the one position in the actual space input by the user into the remote controller and then send the one position in the actual space to the aircraft. The aircraft may receive and use the one position in the actual space as the first predetermined position.

During the flight of the aircraft along the first predetermined direction, whether the current position of the aircraft is the first predetermined position may be determined. If the current position of the aircraft includes the first predetermined position, the current position of the aircraft may be determined as the surrounding-start position.

In some other embodiments, as shown in FIG. 7, determining the surrounding-end position for ending the flight around the to-be-photographed object includes the following processes.

At S501, a surrounding parameter of the flight around the to-be-photographed object is determined in real-time.

In the present disclosure, the surrounding parameter may include a surrounding angle of the flight of the aircraft around the to-be-photographed object, a surrounding distance of the flight of the aircraft around the to-be-photographed object, or a surrounding time length of the flight of the aircraft around the to-be-photographed object.

At S502, the surrounding-end position is determined according to the surrounding parameter.

In some embodiments, the surrounding parameter may include the surrounding angle of the flight of the aircraft around the to-be-photographed object.

In process S502, when the surrounding angle is greater than or equal to the predetermined angle, the current position of the aircraft may be determined as the surrounding-end position. the predetermined angle may include a surrounding angle that is set for the aircraft by the user through the remote controller. That is, the maximum surrounding angle of the flight of the aircraft around the to-be-photographed object may be the predetermined angle. when the surrounding angle is greater than or equal to the predetermined angle, the aircraft may end the flight around the to-be-photographed object.

In some other embodiments, the surrounding parameter may include the surrounding distance of the flight of the aircraft around the to-be-photographed object. In process S502, when the surrounding distance is greater than or equal to the predetermined distance, the current position of the aircraft may be determined as the surrounding-end position. The predetermined distance may include a surrounding distance that is set for the aircraft by the user through the remote controller. That is, the maximum surrounding distance of the flight of the aircraft around the to-be-photographed object may be the predetermined distance. When the surrounding distance is greater than or equal to the predetermined distance, the aircraft may end the flight around the to-be-photographed object.

In some other embodiments, as shown in FIG. 8, determining the surrounding-end position for ending the flight around the to-be-photographed object includes the following processes.

At S601, during the flight around the to-be-photographed object, whether a surrounding-end instruction for instructing to end the flight around the to-be-photographed object is received is detected.

In some embodiments, during the flight around the to-be-photographed object from the surrounding-start position, the aircraft may continuously capture the image including the to-be-photographed object and then transmit the captured image to the remote controller that is configured to control the aircraft. The remote controller may receive the image transmitted by the aircraft and display the image on the display. After seeing the image displayed on the display, the user may see the to-be-photographed object in the image. Thus, the user may determine when to control the aircraft to end the flight around the to-be-photographed object according to the position of the to-be-photographed object in the image. When the aircraft needs to be controlled to end the flight around the to-be-photographed object, the user may input the surrounding-end instruction for instructing to end the flight around the to-be-photographed object into the remote controller. The remote controller may receive the surrounding-end instruction and send the surrounding-end instruction to the aircraft. The aircraft may receive the surrounding-end instruction.

When the surrounding-end instruction is received, in process S602, the current position of the aircraft is determined as the surrounding-end position.

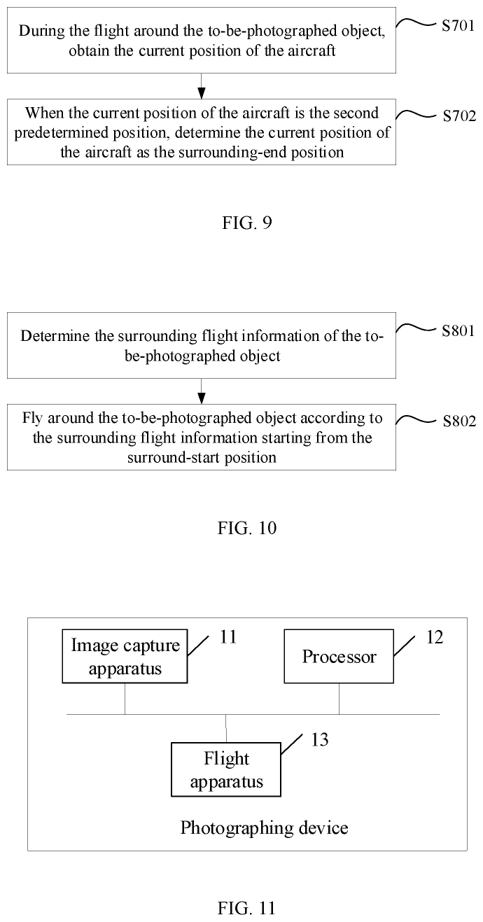

In some other embodiments, as shown in FIG. 9, determining the surrounding-end position for ending the flight around the to-be-photographed object includes the following processes.

At S701, during the flight around the to-be-photographed object, the current position of the aircraft is obtained.

During the flight around the to-be-photographed object from the surrounding-start position, the aircraft may position itself in real-time to obtain the current position of the aircraft. The surrounding-end position may be determined according to the current position of the aircraft.

At S702, when the current position of the aircraft is the second predetermined position, the current position of the aircraft is determined as the surrounding-end position.

In some embodiments, before the flight along the first predetermined direction or during the flight along the first predetermined direction or around the to-be-photographed object, the aircraft may capture the image including the to-be-photographed object and transmit the captured image to the remote controller, which may be configured to control the aircraft. The remote controller may receive the image transmitted by the aircraft and display the transmitted image on the display. After seeing the image displayed on the display of the remote controller, the user may see the to-be-photographed object in the image to determine one position as the surrounding-end position in the image. The remote controller may receive the one position determined by the user in the image. The position of the one position in the actual space may be determined by using image recognition technology. Then, the determined position of the one position in the actual space may be sent to the aircraft. The aircraft may receive and use the determined position of the one position in the actual space as the second predetermined position.

In some other embodiments, the user may directly input a position in the actual space as the surrounding-end position into the remote controller. The remote controller may receive the position in the actual space input by the user into the remote controller and send the position in the actual space to the aircraft. The aircraft may receive and use the position in the actual space as the second predetermined position.

During the flight around the to-be-photographed object, whether the current position of the aircraft is the second predetermined position may be determined. If the current position of the aircraft is the second predetermined position, the current position of the aircraft may be determined as the surrounding-end position.

In some embodiments, as shown in FIG. 10, starting the flight around the to-be-photographed object from the surrounding-start position includes the following processes.

At S801, the surrounding flight information of the to-be-photographed object is determined.

At S802, the aircraft flies around the to-be-photographed object according to the surrounding flight information, starting from the surrounding-start position.

In some embodiments, the surrounding flight information may include a predetermined surrounding path. In process S802, the aircraft may fly around the to-be-photographed object according to the predetermined surrounding path from the surrounding-start position.

In some embodiments, the surrounding path for the flight around the to-be-photographed object may be determined through any one of the following three methods.

In some embodiments, before the flight along the first predetermined direction, the aircraft may capture the image including the to-be-photographed object and transmit the image to the remote controller, which may be configured to control the aircraft. The remote controller may receive the image transmitted by the aircraft and display the transmitted image on the display. After seeing the image displayed on the display of the remote controller, the user may see the to-be-photographed object in the image to determine a plurality of positions as flight points of the surrounding path for the flight around the to-be-photographed object in the image. The remote controller may receive the plurality of positions determined by the user in the image. Positions of the plurality of positions in the actual space may be recognized by using image recognition technology. Then, the positions of the plurality positions in the actual space may be sent to the aircraft. The aircraft may receive the positions of the plurality positions in the actual space. Then, the aircraft may determine the surrounding path for the flight around the to-be-photographed object according to the positions of the plurality positions in the actual space.

In some other embodiments, the user may directly input a plurality of positions in the actual space as the flight points of the surrounding path for the flight around the to-be-photographed object into the remote controller. The remote controller may receive the plurality of positions input by the user and then send the plurality of positions to the aircraft. The aircraft may receive the plurality of positions and determine the surrounding path for the flight around the to-be-photographed object according to the plurality of positions.

In some other embodiments, the user may directly input the position of the to-be-photographed object into the remote controller. The remote controller may receive the position of the to-be-photographed object input by the user and send the position of the to-be-photographed object to the aircraft. The aircraft may receive the position of the to-be-photographed object and determine a plurality of flight points of the aircraft according to the position of the to-be-photographed object. The aircraft may also determine the surrounding path for the flight around the to-be-photographed object based on the plurality of flight points.

In some other embodiments, the distance between the surrounding-start position and the to-be-photographed object may be determined. For example, the distance between the surrounding-start position and the to-be-photographed object may be determined through a vision sensor arranged at the aircraft. Then, the surrounding path may be determined according to the distance. That is, a distance between each position of the surrounding path and the distance between the surrounding-start position and the to-be-photographed object may be determined may be equal to the distance or may be within a predetermined distance range. The predetermined distance range may include a distance range determined based on the distance. For example, a difference between the distance and a predetermined value may be calculated, and a sum of the distance and a predetermined value may be calculated. The difference and the sum may be used as endpoints to determine the distance range.

The determination method of the surrounding path is not limited to the above-described content.

In some other embodiments, the surrounding flight information may include a surrounding radius. When the surrounding flight information of the to-be-photographed object is determined, the distance between the surrounding-start position and the to-be-photographed object may be determined as the surrounding radius. Then, when flying around the to-be-photographed object from the surrounding-start position, the aircraft may fly around the to-be-photographed object according to the surrounding radius from the surrounding-start position.

Correspondingly, the surrounding path may be predetermined. The flight of the aircraft may be controlled according to the surrounding path, as long as whether the current position of the aircraft matches the surrounding path may be determined in real-time. The surrounding radius may also be predetermined. However, during the flight of the aircraft, the distance between the aircraft and the to-be-photographed object may need to be aware of all the time. In practical applications, an appropriate method may be selected to control the surrounding flight of the aircraft individually or combined according to the needs.

In the present disclosure, if the aircraft is controlled based on a predetermined event indicated in a configured control regulation, the flight of the aircraft may be controlled according to the predetermined event when the predetermined event happens.

The predetermined event may include one or more of an abnormal interruption event, an obstacle avoidance response event, and a user manipulation event.

The abnormal interruption event may include one or more of disconnection of the aircraft from the control terminal of the aircraft, disconnection of the aircraft from the application program used to control the aircraft, abnormal execution of the aircraft for the image transmission function, the distance between the aircraft and the control terminal of the aircraft greater than a first distance threshold, the distance between the aircraft and the flight limited area smaller than a second distance threshold, abnormal execution of the positioning function of the aircraft, abnormal depth image determined by the aircraft, and abnormal execution of the aircraft for the data reception and transmission function.

When the abnormal interruption event happens, prompt information may be sent to the control terminal of the aircraft, such that the control terminal may prompt the user that the aircraft has stopped the current photographing and/or the reason for stopping the current photographing. Thus, the user may obtain that the aircraft has stopped the current photographing and/or the reason for stopping the current photographing, which may avoid reducing the user experience since the user cannot obtain the reason that the aircraft stopped the current photographing.

Further, when the obstacle avoidance response event and the user manipulation event happen, the aircraft may be controlled correspondingly as needed. For example, the aircraft may be controlled to hover, flight back, or land to ensure the safety of the aircraft.

In some embodiments, the obstacle avoidance response event may include an obstacle avoidance event. For example, during the flight of the aircraft, another object may abruptly enter the flight path of the aircraft as needed or may be always in the flight path of the aircraft. Then, the aircraft may collide with the object to affect the flight safety of the aircraft. When the obstacle avoidance response event happens, the aircraft may be controlled to change the flight path. After the aircraft flies around the obstacle, the aircraft may return to the flight path to continue to fly along the flight path, or when the aircraft may be controlled to hover until the obstacle leaves the flight path of the aircraft, the aircraft may be controlled continuously to fly along the flight path. After the aircraft is controlled to change the flight path, or when the aircraft is controlled to hover, the aircraft may be controlled to stop photographing the to-be-photographed object and also to continuously photograph the to-be-photographed object.

The user manipulation event may include one or more of a manipulation event of instructing the aircraft to fly back, a manipulation event of instructing the aircraft to land, a manipulation event of instructing the aircraft to hover, a manipulation event of instructing the aircraft to change the flight direction and/or speed. For example, the user may input a manipulation instruction for manipulating the aircraft into the control terminal. The control terminal of the aircraft may obtain the manipulation instruction input by the user and send the manipulation instruction to the aircraft. The aircraft may receive the manipulation instruction and manipulate the aircraft according to the manipulation instruction, for example, control the aircraft to fly back, land, hover, and change the flight direction or speed.

Based on the above description, exemplary scenes are described below for the three photographing methods of embodiments of the present disclosure.

In some embodiments, the user may enclose and select the to-be-photographed object on an image transmission screen of a corresponding APP at the control terminal of the aircraft and set the start photographing position and the surrounding-end position (the surrounding-end position being set according to the surrounding angle). The user may further set the flight speed of the aircraft. Then, the aircraft may automatically perform forward-pointing flight (i.e., fly facing the start photographing position) from the surrounding-start position and photograph the to-be-photographed object when flying to the start photographing position in the forward-pointing flight. When the to-be-photographed object reaches a certain position of the image transmission screen (e.g., a block for enclosing and selecting the to-be-photographed object reaches an edge of the image transmission screen), the distance between the to-be-photographed object and the aircraft may be estimated through lateral monocular/binocular and forward binocular depth sensors. The aircraft may fly around the to-be-photographed object according to the distance between the to-be-photographed object and the aircraft and photograph the to-be-photographed object during the surrounding flight. When the surrounding angle of the flight around the to-be-photographed object reaches a certain angle, the aircraft may fly backward to get away from the to-be-photographed object (e.g., fly along the opposite direction of the photographing direction) and photograph the to-be-photographed object when flying backward to get away from the to-be-photographed object.

In some other embodiments, the user may enclose and select the to-be-photographed object on the image transmission screen of the APP on the control terminal of the aircraft and select the flight direction and flight speed of the aircraft manually. The user may also click a key to activate the aircraft to start flying. The aircraft may fly according to the flight direction to fly closer to the to-be-photographed object and photograph the to-be-photographed object during the flight. When the aircraft reaches the position where the flight around the to-be-photographed object is expected, the user may click a key at the control terminal of the aircraft. Then, the aircraft may estimate the distance between the to-be-photographed object and the aircraft through the lateral monocular/binocular and forward binocular depth sensors. The aircraft may fly around the to-be-photographed object according to the distance between the to-be-photographed object and the aircraft and photograph the to-be-photographed object during the flight around the to-be-photographed object. When the aircraft reaches a position where the flight around the to-be-photographed object is expected to be ended, the user may click a key at the control terminal of the aircraft. Then, the aircraft may start to fly backward to leave the to-be-photographed object (e.g., fly along the opposite direction of the photographing direction) and photograph the to-be-photographed object when flying backward to leave the to-be-photographed object.

In some other embodiments, the user may select the position of the to-be-photographed object, the surrounding-start position for the flight around the to-be-photographed object, the surrounding-end position for the flight around the to-be-photographed object, the start photographing position, and the end photographing position on the image transmission screen of the APP on the control terminal of the aircraft. Thus, the control terminal of the aircraft may generate the photographing path according to the position of the to-be-photographed object, the surrounding-start position, the surrounding-end position, the start photographing position, and the end photographing position. The control terminal may also send the photographing path to the aircraft, and the aircraft may fly according to the photographing path and photograph the to-be-photographed object when flying along the photographing path.

In some other embodiments, the user may select a certain position of the path for the flight around the to-be-photographed object, the surrounding-start position for the flight around the to-be-photographed object, the surrounding-end position for the flight around the to-be-photographed object, the start photographing position, and the end photographing position on the image transmission screen of the APP at the control terminal of the aircraft. Thus, the control terminal of the aircraft may generate the flight path according to the position of the path for the flight around the to-be-photographed object, the surrounding-start position, the surrounding-end position, the start photographing position, and the end photographing position. The control terminal may also send the flight path to the aircraft, and the aircraft may fly according to the flight path and photograph the to-be-photographed object when flying along the flight path.

During the flight of the aircraft, to ensure the continuity and stability of the captured picture or to ensure to maintain the to-be-photographed object to be at a predetermined position of the captured picture, the camera angle of view of the aircraft may be corrected as needed.

In some embodiments, for simple description, the methods are expressed as a series of action combinations, but those skilled in the art should know that the present disclosure is not limited by the described sequence of actions. According to this application, some processes may be performed in another sequence or simultaneously. Those skilled in the art should also know that embodiments described in the specification are some embodiments, and the actions involved are not necessarily required by the present disclosure.

FIG. 11 is a schematic structural diagram of a photographing device according to some embodiments of the present disclosure. The device is used in the aircraft and includes an image capture apparatus 11, a processor 12, and a flight apparatus 13. The image capture apparatus 11 and the processor 12 are arranged in the flight apparatus 13. The device may include an aircraft or a portion of the aircraft.

The image capture apparatus 11 may be configured to photograph the to-be-photographed object when flying along the first predetermined direction. The processor 12 may be configured to determine the surrounding-start position for the flight around the to-be-photographed object. The flight apparatus 13 may be configured to fly around the to-be-photographed object from the surrounding-start position. The image capture apparatus 11 may be further configured to photograph the to-be-photographed object during the flight around the to-be-photographed object. The processor 12 may be further configured to determine the surrounding-end position for ending the flight around the to-be-photographed object. The flight apparatus 13 may be further configured to fly along the second predetermined direction from the surrounding-end position. The image capture apparatus 11 may be further configured to photograph the to-be-photographed object when flying along the second predetermined direction.

In some embodiments, the processor 12 may be further configured to obtain an image including the to-be-photographed object when flying along the first predetermined direction and determine the surrounding-start position according to the image.

In some embodiments, the image may include a captured image of the to-be-photographed object or a preview image of the to-be-photographed object.

In some embodiments, the processor 12 may be further configured to determine a dimension ratio of the dimension of the to-be-photographed object in the image. When the dimension ratio is greater than or equal to the predetermined ratio, the processor 12 may be further configured to the current position of the to-be-photographed object as the surrounding-start position.

In some embodiments, the processor 12 may be further configured to determine the position of the to-be-photographed object in the image, and when the position is in the predetermined position area, determine the current position of the aircraft as the surrounding-start position.

In some embodiments, the processor 12 may be further configured to detect whether the surrounding-start instruction for instructing to start the flight around the to-be-photographed object is received during the flight along the first predetermined direction. When the surrounding-start instruction is received, the processor 12 may be further configured to determine the current position of the aircraft when the aircraft receives the surrounding-start instruction as the surrounding-start position.

In some embodiments, the processor 12 may be further configured to obtain the current position of the aircraft when the aircraft flies along the first predetermined direction and when the current position of the aircraft is determined as the first predetermined position, determine the current position of the aircraft as the surrounding-start position.

In some embodiments, the flight apparatus 13 may be further configured to determine the surrounding flight information of the flight around the to-be-photographed object and photograph the to-be-photographed object according to the surrounding flight information, starting from the surrounding-start position.

In some embodiments, the surrounding flight information may include the predetermined surrounding path. The flight apparatus 13 may be further configured to photograph the to-be-photographed object according to the predetermined surrounding path from the surrounding-start position.

In some embodiments, the surrounding flight information may include the surrounding radius. The flight apparatus 13 may be further configured to determine the distance between the surrounding-start position and the to-be-photographed object as the surrounding radius and fly around the to-be-photographed object according to the surrounding radius from the surrounding-start position.

In some embodiments, the processor 12 may be further configured to determine the surrounding parameter of the flight around the to-be-photographed object and determine the surrounding-end position according to the surrounding parameter.

In some embodiments, the surrounding parameter may include the surrounding angle of the flight around the to-be-photographed object. The processor 12 may be further configured to determine the current position of the aircraft as the surrounding-end position when the surrounding angle is equal to the predetermined angle.

In some embodiments, the surrounding parameter may include the surrounding distance of the flight around the to-be-photographed object. The processor 12 may be further configured to determine the current position of the aircraft as the surrounding-end position when the surrounding distance is equal to the predetermined distance.

In some embodiments, the processor 12 may be further configured to detect whether the surrounding-end instruction for instructing to end the flight around the to-be-photographed object is received during the flight around the to-be-photographed object. When the surrounding-end instruction is received, the processor 12 may determine the current position of the aircraft when the aircraft receives the surrounding-end instruction as the surrounding-end position.

In some embodiments, the processor 12 may be further configured to obtain the current position of the aircraft during the flight around the to-be-photographed object. When the current position of the aircraft is the second predetermined position, the processor 12 may determine the current position of the aircraft as the surrounding-end position.

In some embodiments, the flight apparatus 13 may be further configured to adjust the photographing direction of the aircraft during the flight of the aircraft to cause the to-be-photographed object to be in the predetermined area of the preview image in at least the portion of the surrounding path of the flight around the to-be-photographed object.

In some embodiments, the flight apparatus 13 may be configured to adjust the photographing direction of the aircraft in at least the portion of the flight path of the flight along the first predetermined direction or the second predetermined direction to cause the to-be-photographed object to be in the predetermined area of the preview image in at least the portion of the photographing path of the aircraft. At least the portion of the photographing path may include the surrounding path. The length of at least the portion of the photographing path may be greater than the length of the surrounding path.

In some embodiments, the flight apparatus 13 may be further configured to adjust the photographing direction of the aircraft during the flight of the aircraft to cause the to-be-photographed object to be in the predetermined area of the preview image.

In some embodiments, the first predetermined direction and the second predetermined direction may be symmetrical about the line from the to-be-photographed object to the middle point of the surrounding path around the to-be-photographed object.

In some embodiments, the flight distance of the flight along the first predetermined direction may be equal to the flight distance of the flight along the second predetermined direction.

In some embodiments, during the flight along the second predetermined direction starting from the surrounding-end position, the head orientation of the aircraft may be opposite to the photographing direction of the aircraft or have the obtuse angle with the photographing direction of the to-be-photographed object.

In some embodiments, during the flight along the second predetermined direction starting from the surrounding-end position, the head orientation of the aircraft may be the same as the photographing direction of the aircraft.

In some embodiments, the processor 12 may be configured to if the aircraft is controlled based on the predetermined event indicated in the control regulation that is configured, when the predetermined event happens, control the flight of the aircraft according to the predetermined event.

In some embodiments, the predetermined event may include one or more of an abnormal interruption event, an obstacle avoidance response event, and a user manipulation event.

In some embodiments, the abnormal interruption event may include one or more of disconnection of the aircraft from the control terminals of the aircraft, disconnection of the aircraft from the application program used to control the aircraft, abnormal execution of the aircraft for the image transmission function, the distance between the aircraft and the control terminal of the aircraft greater than a first distance threshold, the distance between the aircraft and the flight limited area smaller than a second distance threshold, abnormal execution of the positioning function of the aircraft, abnormal depth image determined by the aircraft, and abnormal execution of the aircraft for the data reception and transmission function.

In some embodiments, the user manipulation event may include one or more of a manipulation event of instructing the aircraft to fly back, a manipulation event of instructing the aircraft to land, a manipulation event of instructing the aircraft to hover, a manipulation event of instructing the aircraft to change the flight direction and/or speed.

In some embodiments, the processor 12 may be further configured to when the abnormal interruption event happens, send the prompt information to the control terminal of the aircraft to cause the control terminal to prompt the user that the aircraft has stopped the current photographing and/or the reason for stopping the current photographing.

In the present disclosure, the photographing device may be configured to photograph the to-be-photographed object during the flight along the first predetermined direction and determine the surrounding-start position of the flight around the to-be-photographed object, fly around the to-be-photographed object starting from the surrounding-start position, photograph the to-be-photographed object during the flight around the to-be-photographed object, determine the surrounding-end position for ending the flight around the to-be-photographed object, fly along the second predetermined direction starting from the surrounding-end position, and photograph the to-be-photographed object during the flight along the second predetermined direction. As such, the aircraft may capture the awesome video with the following effects for the to-be-photographed object through the present disclosure. The photographing field of view of the aircraft may be getting close to the to-be-photographed object continuously, and the aircraft may photograph the to-be-photographed object when the photographing field of view is getting close to the to-be-photographed object. The aircraft may continue to surround photograph the to-be-photographed object when the photographing field of view is getting close to the to-be-photographed object. When the surround-photographing ends, the photographing field of view may leave the to-be-photographed object continuously. As such, the to-be-photographed object may be photographed continuously with a special field of view through continuous flight actions.

Since device embodiments are basically similar to method embodiments, the description is relatively simple. For relevant description, reference may be made the description of method embodiments.

Embodiments of the present disclosure also provide a computer-readable storage medium. A computer program may be stored on the computer-readable storage medium. When the computer program is executed by a processor, each process of the above-mentioned photographing method embodiments may be realized, and the same technical effect can be achieved, to avoid repetition, which is not repeated here. The computer-readable storage medium may include read-only memory (ROM), random access memory (RAM), magnetic disk, optical disk, etc.

Various embodiments in this specification are described in a progressive manner. Each embodiment focuses on the differences from other embodiments, and the same or similar parts between various embodiments can be referred to each other.

Those skilled in the art should understand that embodiments of the present disclosure may be provided as methods, devices, or computer program products. Therefore, the present disclosure may adopt the form of a complete hardware embodiment, a complete software embodiment, or an embodiment combining software and hardware. Moreover, the present disclosure may adopt the form of a computer program product implemented on one or more computer-readable storage media (including but not limited to disk storage, CD-ROM, optical storage, etc.) including computer-readable program codes.

The present disclosure is described according to the flowchart and/or block diagram of the method, terminal device (system), and computer program product of the present disclosure. Each process and/or block in the flowchart and/or block diagram, and the combination of processes and/or blocks in the flowchart and/or block diagram may be realized by computer program instructions. These computer program instructions may be provided to the processors of a general-purpose computer, a special-purpose computer, an embedded processor, or another programmable data processing terminal equipment to generate a machine, so that the instructions executed by the processor of the computer or another programmable data processing terminal equipment to generate a device configured to realize the functions specified in one or more processes in the flowchart and/or one or more blocks in the block diagram.

These computer program instructions may also be stored in the computer-readable memory that can guide the computer or the another programmable data processing terminal equipment to work in a specific manner, so that the instructions stored in the computer-readable memory may generate a product including the instruction device. The instruction device may implement the functions specified in one or more processes in the flowchart and/or one or more blocks in the block diagram.

These computer program instructions may also be loaded on the computer or the another programmable data processing terminal equipment, so that a series of operation steps are executed on the computer or the another programmable terminal equipment to generate computer-implemented processing, so that the instructions executed on the computer or the another programmable terminal equipment may provide steps for implementing functions specified in a or more flows in the flowchart and/or one or more blocks in the block diagram.

Although some embodiments of the present disclosure have been described, those skilled in the art can make additional changes and modifications to these embodiments once they know the basic creative concept. Therefore, the appended claims are intended to be interpreted as including some embodiments and all changes and modifications within the scope of the present invention.

Finally, relational terms such as first and second are only used to distinguish one entity or operation from another entity or operation, and do not necessarily require or imply such actual relationship or sequence between these entities or operations. Moreover, the terms “including”, “including” or any other variants thereof are intended to cover non-exclusive inclusion, so that a process, method, article, or terminal device including a series of elements not only includes those elements, but also includes other elements that are not explicitly listed, or also include elements inherent to the process, method, article, or terminal device. If there are no more restrictions, the element defined by the sentence “including a . . . ” does not exclude the existence of another identical elements in the process, method, article, or terminal device that includes the element.

The photographing method and device provided by the present disclosure may be described in detail. Specific examples are used in this specification to illustrate the principles and implementation of the present disclosure. The description of embodiments is only used to help understand the method of the present disclosure and its core ideas. At the same time, those ordinary skill in the art, according to the ideas of the present disclosure, changes may be made to the specific implementation and application scope. In summary, the content of the present disclosure should not be considered as a limitation to the present disclosure.

What is claimed is:

1. A photographing method comprising:
photographing a target object during flight along a first predetermined direction;
determining a surrounding-start position for flight around the target object;
flying around the target object starting from the surrounding-start position;
photographing the target object during the flight around the target object;
determining a surrounding-end position for ending the flight around the target object;
flying along a second predetermined direction starting from the surrounding-end position; and
photographing the target object during flight along the second predetermined direction.

2. The method of claim 1, wherein determining the surrounding-start position includes:
obtaining an image including the target object during the flight along the first predetermined direction, and determining the surrounding-start position according to the image; or
during the flight along the first predetermined direction, in response to receiving a surrounding-start instruction, determining a current position of the aircraft as the surrounding-start position; or
during the flight along the first predetermined direction, obtaining the current position of the aircraft, and in response to the current position of the aircraft including a predetermined position, determining the current position of the aircraft as the surrounding-start position.

3. The method of claim 2, wherein the image includes a captured image of the target object or a preview image of the target object.

4. The method of claim 2, wherein determining the surrounding-start position according to the image includes:
determining a dimension ratio of a dimension of the target object in the image, and in response to the dimension ratio being greater than or equal to a predetermined ratio, determining a current position of the aircraft as the surrounding-start position; or
determining a position of the target object in the image, and in response to the position being in a predetermined position area, determining the current position of the aircraft as the surrounding-start position.

5. The method of claim 1, wherein flying around the target object starting from the surrounding-start position includes:
determining surrounding flight information of the target object; and
flying around the target object according to the surrounding flight information, starting from the surrounding-start position.

6. The method of claim 5, wherein:
the surrounding flight information includes a predetermined surrounding path; and
flying around the target object according to the surrounding flight information, starting from the surrounding-start position includes flying around the target object according to the predetermined surrounding path, starting from the surrounding-start position.

7. The method of claim 5, wherein:
the surrounding flight information includes a surrounding radius;
determining the surrounding flight information includes determining a distance between the surrounding-start position and the target object as the surrounding radius; and
flying around the target object according to the surrounding flight information, starting from the surrounding-start position includes flying around the target object according to the surrounding radius, starting from the surrounding-start position.

8. The method of claim 1, wherein determining the surrounding-end position includes:
determining a surrounding parameter of the flight around the target object in real-time, and determining the surrounding-end position according to the surrounding parameter; or
during the flight around the target object, in response to receiving a surrounding-end instruction, determining a current position of the aircraft as the surrounding-end position; or
during the flight around the target object, obtaining the current position of the aircraft, and in response to the current position of the aircraft being a predetermined position, determining the current position of the aircraft as the surrounding-end position.

9. The method of claim 8, wherein:
the surrounding parameter includes a surrounding angle of the flight around the target object; and
determining the surrounding-end position according to the surrounding parameter includes in response to the surrounding angle being equal to a predetermined angle, determining the current position of the aircraft as the surrounding-end position.

10. The method of claim 8, wherein:
the surrounding parameter includes a surrounding distance of the flight around the target object; and
determining the surrounding-end position according to the surrounding parameter includes in response to the surrounding distance being equal to a predetermined distance, determining the current position of the aircraft as the surrounding-end position.

11. The method of claim 1, further comprising:
during flight of the aircraft, adjusting a photographing direction of the aircraft to cause the target object to be in a predetermined area of a preview image in at least one portion of a surrounding path of the flight around the target object.

12. The method of claim 11, wherein:
during the flight of the aircraft, adjusting the photographing direction of the aircraft to cause the target object to be in the predetermined area of the preview image in the at least one portion of the surrounding path includes:
in at least one portion of a flight path of the flight along the first predetermined direction or the second predetermined direction, adjusting the photographing direction of the aircraft to cause the target object to be in the predetermined area of the preview image in at least one portion of a photographing path of the aircraft;
the at least one portion of the photographing path includes the surrounding path; and
a length of the at least one portion of the photographing path is greater than a length of the surrounding path.

13. The method of claim 11, wherein during the flight of the aircraft, adjusting the photographing direction of the aircraft to cause the target object to be in the predetermined area of the preview image in the at least one portion of the surrounding path includes:
during the flight of the aircraft, adjusting the photographing direction of the aircraft to cause the target to be in the predetermined area of the preview image.

14. The method of claim 1, wherein the first predetermined direction and the second predetermined direction are symmetrical about a line from the target object to a middle point of a surrounding path around the target object.

15. The method of claim 14, wherein a flight distance of the flight along the first predetermined direction is equal to a flight distance of the flight along the second predetermined direction.

16. The method of claim 1, wherein during the flight along the second predetermined direction from the surrounding-end position, a head orientation of the aircraft is same as or opposite to a photographing direction of the aircraft, or has an obtuse angle with the photographing direction of the aircraft.

17. The method of claim 1, further comprising:
in response to occurrence of a predetermined event indicated in a configured control regulation, controlling the flight of the aircraft according to the predetermined event.

18. The method of claim 17, wherein the predetermined event includes one or more of an abnormal interruption event, an obstacle avoidance response event, and a user manipulation event.

19. The method of claim 17, further comprising:
in response to occurrence of an abnormal interruption event, sending prompt information to a control terminal of the aircraft to cause the control terminal to prompt at least one of that the aircraft has stopped current photographing or a reason for stopping the current photographing.

20. A photographing device comprising:
an image capture apparatus configured to photograph a target object during flight along a first predetermined direction, during flight around the target object, and during flight along a second predetermined direction;
a processor configured to determine a surrounding-start position for the flight around the target object and a surrounding-end position for ending the flight around the target object; and
a flight apparatus configured to fly around the target object starting from the surrounding-start position and along the second predetermined direction starting from the surrounding-end position.
